(19) United States
(12) Patent Application Publication
(10) Pub. No.: US 2022/0404999 A1
(43) Pub. Date: Dec. 22, 2022

(54) SYSTEM AND METHOD TO CREATE PERSISTENT HOST METADATA LOGS IN NVME SSD

(71) Applicant: Dell Products L.P., Round Rock, TX (US)

(72) Inventors: Vivekanandh Narayanasamy RAJAGOPALAN, Bangalore (IN); Swee Chay HIA, Singapore (SG); Ambadas Devrao JADHAV, Ahmednagar District (IN)

(73) Assignee: Dell Products L.P., Round Rock, TX (US)

(21) Appl. No.: 17/375,329

(22) Filed: Jul. 14, 2021

(30) Foreign Application Priority Data
Jun. 16, 2021 (IN) 202111026845

(51) Int. Cl. G06F 3/06

(52) U.S. Cl. CPC G06F 3/0652; G06F 3/0679; G06F 3/0604

(57) ABSTRACT

An information handling system may include at least one processor; and a Non-Volatile Memory Express (NVMe) solid state drive (SSD) communicatively coupled to the at least one processor; wherein the information handling system is configured to: collect telemetry information regarding the information handling system; and log the telemetry information in a vendor-specific portion of the NVMe SSD via an NVMe set command.

### TECHNICAL FIELD

The present disclosure relates in general to information handling systems, and more particularly to securely storing logging information in physical storage resources such as Non-Volatile Memory Express (NVMe) solid state drives (SSDs).

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Currently, the analysis of a failed storage resource such as an NVMe SSD may depend to a large extent on the environment in which it was deployed. For example, telemetry data including the system name, system hardware details, operating system identity and version, storage drivers and versions, other drivers and versions, etc. may be of considerable use in analyzing failures. In the absence of this information, it can be time-consuming to analyze the reason for failure, simulate the failure in the correct environment, etc., and arriving at a correct root cause is difficult.

Accordingly, embodiments of this disclosure may use commands such as the NVMe set and get administration commands respectively to write and retrieve host metadata in a host metadata log page of an NVMe SSD. This log page may persist across power cycles as well as formatting of the drive, but it may be erased by performing a sanitization of the drive.

It is to be noted that various terms discussed herein are described in the NVMe 1.4 Specification, which was released on Jul. 23, 2019 (hereinafter, NVMe Specification), which is hereby incorporated by reference in its entirety. One of ordinary skill in the art with the benefit of this disclosure will understand its applicability to other specifications (e.g., prior or successor versions of the NVMe Specification). Further, some embodiments may be applicable to different technologies other than NVMe.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with log storage in physical storage resources may be reduced or eliminated.

In accordance with embodiments of the present disclosure, an information handling system may include at least one processor; and a Non-Volatile Memory Express (NVMe) solid state drive (SSD) communicatively coupled to the at least one processor; wherein the information handling system is configured to: collect telemetry information regarding the information handling system; and log the telemetry information in a vendor-specific portion of the NVMe SSD via an NVMe set command.

In accordance with these and other embodiments of the present disclosure, a method may include an information handling system that includes a Non-Volatile Memory Express (NVMe) solid state drive (SSD) collecting telemetry information regarding the information handling system; and the information handling system logging the telemetry information in a vendor-specific portion of the NVMe SSD via an NVMe set command.

In accordance with these and other embodiments of the present disclosure, an article of manufacture may include a non-transitory, computer-readable medium having computer-executable code thereon that is executable by a processor of an information handling system for: collecting telemetry information regarding the information handling system; and logging the telemetry information in a vendor-specific portion of a Non-Volatile Memory Express (NVMe) solid state drive (SSD) via an NVMe set command.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates a block diagram of an example log storage architecture, in accordance with embodiments of the present disclosure.

### DETAILED DESCRIPTION

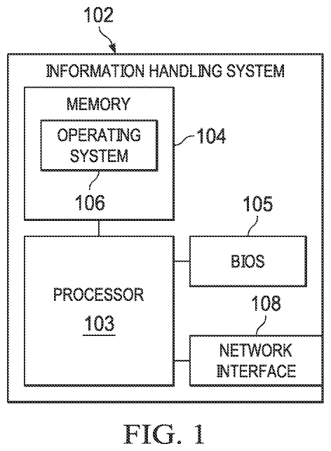

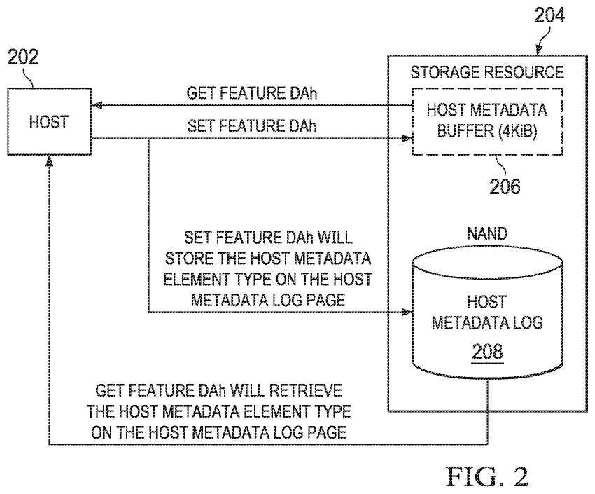

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile and/or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

In some embodiments, memory 104 may include one or more physical storage resources such as NVMe drives (e.g., NVMe SSDs). As discussed above, it would be advantageous to be able to store persistent logging information in a defined location of such a drive. In some embodiments, NVMe get and set administration commands may be used for this purpose. In particular, a vendor-specific feature identifier (e.g., DAh) may be used for this purpose. The log stored in this way may always carry the latest host metadata information.

The initial logs with host metadata information may be written when a system is first configured (e.g., at the factory). Once a system has been deployed, a software agent may include a custom inventory collector module to read and update the host metadata as needed. Any changes in the host metadata parameters may be detected immediately by using a change listener module of the software agent, and the host metadata log page may then be updated accordingly. In some embodiments, the host metadata may change only under defined circumstances, such as when the operating system, drivers, or SSD firmware is updated.

Other embodiments of this disclosure may be implemented in an “agentless” fashion. For example, some systems may not have a software agent that runs at all times, but may have only a boot-time component that uses Windows Management Instrumentation (WMI) or similar technology. In such cases, the log may be updated at boot.

The following section describes in detail some of the data and command structures that may be used in one implementation. One of ordinary skill in the art with the benefit of this disclosure will understand that they are merely one example of an implementation, and that in other embodiments, the details may vary.

In some embodiments, an identify controller data structure may be laid out as described below in Table 1. In particular, this table specifies the vendor-specific usage of the vendor-specific area (offset 3072 to 4095) of the identify controller data structure. All vendor-specific words discussed herein may be returned by reading the controller data structure using the identify command, as discussed in the NVMe Specification.

TABLE 1

| | |
|---|---|
| Offset | Size |

| Word | Start | End | (Bytes) | Description |
|---|---|---|---|---|
| 4 | 3108 | 3109 | 2 | Vendor Unique Features |

| Bit | Description | |
|---|---|---|
| 15 | Contents of this word are valid; | |
| | set to 1 | |
| 14:2 | Reserved; shall be programmed | |
| | to 0 | |
| 1 | Host | 1 - supported |
| | Metadata | 0 - not |
| | Log | supported |
| 0 | Other | 1 - supported |
| | feature | 0 - not |
| | | supported |

The host metadata set features command if the feature identifier specified by that command is supported to be logged. If logging of a host metadata feature is supported, then the log is able to contain information about the system environment in which the NVMe drive is installed and which can be retrieved for diagnostic purposes. Because each element type is defined, diagnostic software used by different vendors to retrieve the log can interpret the information across multiple systems and sites.

A requester may send a host metadata data structure (see Table 4 below) via the set features command specifying one of the host metadata features. The requester may then receive a host metadata data structure via the get features command specifying one of the host metadata features. The host metadata features may use NVMe set features command Dword 11 as shown in Table 2 below.

| Bit | Description |
|---|---|
| 31:15 | Reserved |
| | Element Action (EA): This field specifies the action |
| | to perform on the specified host metadata feature |
| | value for each metadata element descriptor data |
| | structure contained in the host metadata data |
| | structure. |

| | |
|---|---|
| Value | Definition |
| 00b | Add/Replace Entry |
| 01b | Delete Entry |
| 10b to 11b | Reserved |

| | |
|---|---|
| 14 :13 | If the element action field is cleared to 00b |
| | (add/replace entry) and a metadata element descriptor |
| | with the specified element type (see Table 6) does not |
| | exist in the specified host metadata feature value, |
| | then the host may create the descriptor in the |
| | specified host metadata feature value with the value |
| | in the host metadata data structure. |
| | If the element action field is cleared to 00b |
| | (add/replace entry) and one metadata element |
| | descriptor with the specified element type exists in |
| | the specified host metadata feature value, then the |
| | host may replace the descriptor with the value in the |
| | specified host metadata data structure. |
| | If the element action field is set to 01b (delete |
| | entry), then the host may delete all of the specified |
| | metadata element descriptors from the specified host |
| | metadata feature value, if any. If none of the |
| | specified metadata element descriptors are present in |
| | the specified host metadata feature value, then the |
| | host may complete the set features command with a |
| | status of successful completion and not change any |
| | host metadata feature value. |

| | |
|---|---|
| 12 : 00 | Reserved |

| | | |
|---|---|---|
| Table | 2 (set features - | command Dword 11). |

New metadata element descriptors may be added, replaced, or deleted based on the action specified in the element action field. Modification of the host metadata feature value may be performed by the host in an atomic manner in some embodiments.

If a set features command is submitted for a host metadata feature, a host metadata data structure (see Table 4) may be transferred in the data buffer for the command. The host metadata data structure may be 128 bytes in size in one embodiment, and it may contain zero or one metadata element descriptors. If host software attempts to add or replace a metadata element that causes the host metadata feature value of the specified feature to grow larger than 128 Bytes, the drive may abort the command with an invalid field in command.

In some embodiments, 32 host metadata element types (see Table 6) may be available (e.g., 32-Types/Page×128-Bytes/Type=4 KiB/Page). Every type may have a maximum size of 128 bytes (or 128 characters as represented in ASCII code in some embodiments). The host software may pad the remaining bytes in the system environment string with spaces (e.g., ASCII 20 h). It may truncate any system environment information string that is larger than 128 characters. Only one host metadata element type is sent and received via the set features command and the get features command respectively.

A set features command specifying one of the host metadata features does not affect the value of the other host metadata features. The host metadata features may use NVMe get features command Dword 11 as shown in Table 3. If a get features command is issued specifying one of the host metadata features, the metadata element descriptors present in the specified host metadata feature value may be added to a host metadata data structure (see Table 4) and returned in the data buffer for that command. If a get feature command is issued to request for return of any metadata element type that was not previously written, then the drive may return zero (e.g., a NULL character) as the element value for the metadata element type. Table 3 below illustrates get features using command Dword 11.

| Bit | Description | | |
|---|---|---|---|
| 31:15 | Reserved | | |
| 14 :13 | Element Action (EA): This field shall be cleared to | | |
| | Oh. | | |
| 12 : 06 | Reserved | | |
| 05 : 00 | | Element Type (ET): This field specifies the type of | |
| | | metadata stored in the descriptor. | |
| | | Value | Definition |
| | | OOh | Reserved |
| | | Olh to | Element types defined by this |
| | | 17h | specification. Host metadata element |
| | | | types are defined in Table 6 |
| | | 18h to | Vendor Specific |
| | | lFh | |

Table 3 (get features - command Dword 11)

Table 4 below illustrates an example host metadata data structure.

| | |
|---|---|
| Byte | Description |
| 00 | Number of Metadata Element Descriptors: This field contains |
| | the number of metadata element descriptors in the data |
| | structure. |
| 01 | Reserved |
| x:02 | Metadata Element Descriptor 0: This field contains the first |
| | metadata element descriptor. |

Table 4 (host metadata data structure).

If the feature identifier field specifies host metadata, then the host metadata data structure may contain at most one metadata element descriptor of each element type. Each metadata element descriptor may contain the data structure shown in Table 5 below.

| Bit | Description | | |
|---|---|---|---|
| 31 + (Element | Element Value | (EVAL): | This field specifies the value for |
| Length*8) :32 | the element. | | |
| Bit | Description | | |
| 31:16 | Element Length (ELEN): This field specifies the length of | | |
| | the element value field in bytes. This field may be Oh when | | |
| | deleting an entry (EA = 01b) . This field may be non-zero | | |
| | when adding/updating and entry (EA = 00b). | | |
| 15 :12 | Reserved | | |
| 11: 08 | Element Revision (ER) : This field specifies the revision of | | |
| | this element value. Unless specified otherwise, all | | |
| | metadata element descriptors may clear this field to a value | | |
| | of Oh. | | |
| 07:06 | Reserved | | |
| 05 : 00 | Element Type (ET): This field specifies the type of metadata | | |
| | stored in the descriptor. | | |
| | | Value | Definition |
| | | OOh | Reserved |
| | | Olh to 17h | Element types defined herein. Host |
| | | | metadata element types are defined in |
| | | | Table 6. |
| | | 18h to lFh | Vendor Specific |

Table 5 (metadata element descriptor).

| 5 | Table 6 below describes host metadata (feature | |
|---|---|---|
| | identifier DAh). This feature may be used to store metadata | |
| | about the host platform in an NVM Subsystem for later | |
| | retrieval. The metadata element types defined in Table 6 are | |
| | used by this feature. | |
| | Value | Definition |
| | OOh | Reserved |
| | Olh | Operating System Host Name: The name of the host in the |
| | | operating system as a ASCII string. |
| | 02h | Operating System Driver Name: The name of the driver in the |
| | | operating system as a ASCII string. |
| | 03h | Operating System Driver Version: The version of the driver in |
| | | the operating system as a ASCII string. |
| | 04h | Pre-boot Host Name: The name of the host in the pre-boot |
| | | environment as a ASCII string. |
| | 05h | Pre-boot Driver Name: The name of the driver in the pre-boot |
| | | environment as a ASCII string. |
| | 06h | Pre-boot Driver Version: The version of the driver in the |
| | | pre-boot environment as a ASCII string. |
| | 07h | System Processor Model: The model of the processor as a ASCII |
| | | string. |
| | 08h | Chipset Driver Name: The chipset driver name as a ASCII |
| | | string. |
| | 09h | Chipset Driver Version: The chipset driver version as a ASCII |
| | | string. |

| | |
|---|---|
| Value | Definition |
| OAh | Operating System Name and Build: The operating system name |
| | and build as a ASCII string. |
| OBh | System Product Name: The system product name as a ASCII |
| | string. |
| OCh | Firmware Version: The host firmware (e.g., UEFI) version as |
| | a ASCII string. |
| ODh | Operating System Driver Filename: The operating system driver |
| | filename as a ASCII string. |
| OEh | Display Driver Name: The display driver name as a ASCII |
| | string. |
| OFh | Display Driver Version: The display driver version as a ASCII |
| | string. |
| lOh | Host-Determined Failure Record: A failure record (e.g., the |
| | reason the host has flagged a failure, which may be used for |
| | failure analysis) as a ASCII string. |
| llh to | Reserved |
| 17h | |
| 18h to | Vendor Specific |
| lFh | |
| Table 6 | host metadata element types). |

Table 6 below describes host metadata (feature identifier DAh). This feature may be used to store metadata about the host platform in an NVM Subsystem for later retrieval. The metadata element types defined in Table 6 are used by this feature.

Turning now to FIG. 2, an example log storage architecture is shown. Host system 202 may include or otherwise be coupled to a storage resource 204. In some embodiments, storage resource 204 may be an NVMe drive such as an SSD.

As discussed above, host 202 may use NVMe get/set commands to store logging information in a host metadata log of storage resource 204. In some embodiments, storage resource 204 may include a small host metadata buffer 206, which may be stored in volatile storage and may be cleared when storage resource 204 is powered down or reset. Host metadata log 208 may be stored in non-volatile storage such as NAND flash, and its contents may be retained across resets and power cycles (although it may be cleared when storage resource 204 is sanitized). The data stored in host metadata buffer 206 may be periodically flushed to host metadata log 208.

In some embodiments, each feature identifier (as discussed above) may include its own host metadata buffer 206, such that changes to one feature identifier need not affect any other feature identifier.

Although various possible advantages with respect to embodiments of this disclosure have been described, one of ordinary skill in the art with the benefit of this disclosure will understand that in any particular embodiment, not all of such advantages may be applicable. In any particular embodiment, some, all, or even none of the listed advantages may apply.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Unless otherwise specifically noted, articles depicted in the drawings are not necessarily drawn to scale. However, in some embodiments, articles depicted in the drawings may be to scale.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a Non-Volatile Memory Express (NVMe) solid state drive (SSD) communicatively coupled to the at least one processor;
wherein the information handling system is configured to:
collect telemetry information regarding the information handling system; and
log the telemetry information in a vendor-specific portion of the NVMe SSD via an NVMe set command.

2. The information handling system of claim 1, wherein the telemetry data is collected in real-time via a software agent executing on the information handling system.

3. The information handling system of claim 1, wherein the telemetry data includes at least one of a name of the information handling system, hardware information, operating system information, and driver information.

4. The information handling system of claim 1, wherein the logged telemetry information is configured to persist in the NVMe SSD during a reboot.

5. The information handling system of claim 1, wherein the logged telemetry information is configured to persist in the NVMe SSD during a format operation of the NVMe SSD.

6. The information handling system of claim 1, wherein the logged telemetry information is configured to be erased by a sanitize operation of the NVMe SSD.

7. A method comprising:
an information handling system that includes a Non-Volatile Memory Express (NVMe) solid state drive (SSD) collecting telemetry information regarding the information handling system; and
the information handling system logging the telemetry information in a vendor-specific portion of the NVMe SSD via an NVMe set command.

8. The method of claim 7, wherein the telemetry data is collected in real-time via a software agent executing on the information handling system.

9. The method of claim 7, wherein the telemetry data includes at least one of a name of the information handling system, hardware information, operating system information, and driver information.

10. The method of claim 7, wherein the logged telemetry information is configured to persist in the NVMe SSD during a reboot.

11. The method of claim 7, wherein the logged telemetry information is configured to persist in the NVMe SSD during a format operation of the NVMe SSD.

12. The method of claim 7, wherein the logged telemetry information is configured to be erased by a sanitize operation of the NVMe SSD.

13. An article of manufacture comprising a non-transitory, computer-readable medium having computer-executable code thereon that is executable by a processor of an information handling system for:
collecting telemetry information regarding the information handling system; and
logging the telemetry information in a vendor-specific portion of a Non-Volatile Memory Express (NVMe) solid state drive (SSD) via an NVMe set command.

14. The article of claim 13, wherein the telemetry data is collected in real-time via a software agent executing on the information handling system.

15. The article of claim 13, wherein the telemetry data includes at least one of a name of the information handling system, hardware information, operating system information, and driver information.

16. The article of claim 13, wherein the logged telemetry information is configured to persist in the NVMe SSD during a reboot.

17. The article of claim 13, wherein the logged telemetry information is configured to persist in the NVMe SSD during a format operation of the NVMe SSD.

18. The article of claim 13, wherein the logged telemetry information is configured to be erased by a sanitize operation of the NVMe SSD.
